(19) United States
(12) Patent Application Publication
(10) Pub. No.: US 2001/0024022 A1
(43) Pub. Date: Sep. 27, 2001

(54) Worker supporting slider-creeper

(76) Inventor: Russell J. Antirose, Greenville, RI (US)

Correspondence Address: R . J . Doherty, 11 George St., Barrington, RI, 02806, US

(21) Appl. No.: 09/812,748

(22) Filed: Mar. 20, 2001

Related U.S. Application Data
(63) Continuation-in-part of application No. 09/294,770, filed on Apr. 19, 1999.

(51) Int. Cl. B25H 5/00

(52) U.S. Cl. 280/32.6

(57) ABSTRACT

A support device of the type referred to as a slider-creeper for working in confined work areas and particularly for plumbers working on under cabinet piping and comprising a flat body having opposed generally flat upper and lower surfaces with a major supporting stop downwardly extending from a forward portion of the lower body surface such that the working person can lie on the top surface for support.

This application is a Continuation-in-Part of my previous application Ser. No. 09/294,770 filed Apr. 19, 1999 and which is incorporated herein by reference thereto.

### FIELD OF THE INVENTION

This invention relates generally to equipment on which a worker may lie in a prone position in order to access hard-to-reach places and which is often referred to as a creeper or slider. Generally, such workers find it difficult to access hard-to-reach-confined areas. Most commonly, such devices are utilized to work underneath automobiles or machinery; and although this invention does not exclude such uses, its primary application is intended for plumbers working within kitchen or other cabinetry in which the plumbing is located and which includes a raised platform or ledge extending above the general supporting surface—normally the floor of the kitchen or other room. Typically, the creepers of prior art devices include a flat support on which a worker may lie on his or her back and means by which the device may be slid into the confined area.

### DESCRIPTION OF THE PRIOR ART

U.S. Pat. No. 1,248,839 to Fravel shows a slidable truck or support which is comprised of a plurality of sections hingedly connected together for the above-indicated general purpose;

U.S. Pat. No. 1,764,757 to Slee shows a creeper having a general head support area and means on the lower body supporting surface to facilitate sliding of the device into inaccessible places;

U.S. Pat. No. 3,677,569 to Larson shows a foldable crawler having extendible sections that are adapted to provide a surface on which the person performing the work may rest;

U.S. Pat. No. 4,185,846 to Black includes a creeper that provides a novel slider mechanism on the bottom surface thereof by which the device can be manipulated to move along its supporting surface;

U.S. Pat. No. 4,909,524 to Paine shows a slider-creeper of the type having an upper surface and conforming to the workman's back; and

U.S. Pat. No. 5,022,670 to Cote et al shows a separable creeper having easily removable wheels and a plow-like device attached to the forward portion for moving obstructing materials out of the way while being used.

### SUMMARY OF THE INVENTION

While the above indicated prior art devices and those generally available in the field are satisfactory for their intended purposes, no particular device which is specifically adapted for use in reaching inaccessible work areas within cabinetry in which plumbing is housed is known and, accordingly, an object of the present invention is the provision of such a slider-creeper device for such intended specific purpose. It is a further object of the present invention to provide a device which enables such specific objective to be achieved by the provision of a simple, inexpensive and easily transportable device which not only provides the necessary support for the workman to accomplish his tasks but which does so without the risk of damage to the aforementioned cabinetry, floors or worker. A further object is to provide a device which is easy to use and which properly and safely supports the worker while performing the functions at task so as to, in effect, provide a proactive health product.

These and other objects of the present invention are provided by a support device that a person may lie upon for working in confined work areas comprising a broad generally flat body of overall elongated configuration and having forward, central and rear portions thereof, said body further having a first upper generally flat surface and an opposite generally flat second lower surface which lower surface includes a narrow laterally oriented downwardly extending major supporting stop in turn having a lower flat wall for contacting a supporting surface of the work area, a minor portion of said lower surface extending forwardly of said major stop, said major stop positioned proximal the forward area of said body such that the person supported on the upper body surface with his or her head supported by the body forward portion can tilt the support device between alternate positions.

Other objects, features and advantages of the invention shall become apparent as the description thereof proceeds when considered in connection with the accompanying illustrative drawings.

### BRIEF DESCRIPTION OF THE DRAWINGS

In the drawings which illustrate the best mode presently contemplated for carrying out the present invention:

FIG. 1 is a perspective view showing a worker carrying the device of the present invention to a work site;

FIG. 2 is a front perspective view of such a preferred work site in which the device of the present invention is particularly adapted for use, namely, to work on plumbing within a cabinet, e.g., a kitchen cabinet;

FIG. 3 is a partial side elevational view taken along the line 3-3 of FIG. 2;

FIG. 4 is a side elevational view similar to FIG. 3 but showing another position of the device and illustrating further inward progression of the device into the cabinet than illustrated in FIG. 3;

FIG. 5 is a partial sectional view similar to FIG. 4 but showing a work position of the device generally parallel to the support surface;

FIG. 6 is a partial planar view of the device of the present invention, namely, the forward lower surface thereof; and

FIG. 7 is a partial planar view of the device of the present invention, that is, its upper central portion.

### DESCRIPTION OF THE PREFERRED EMBODIMENTS

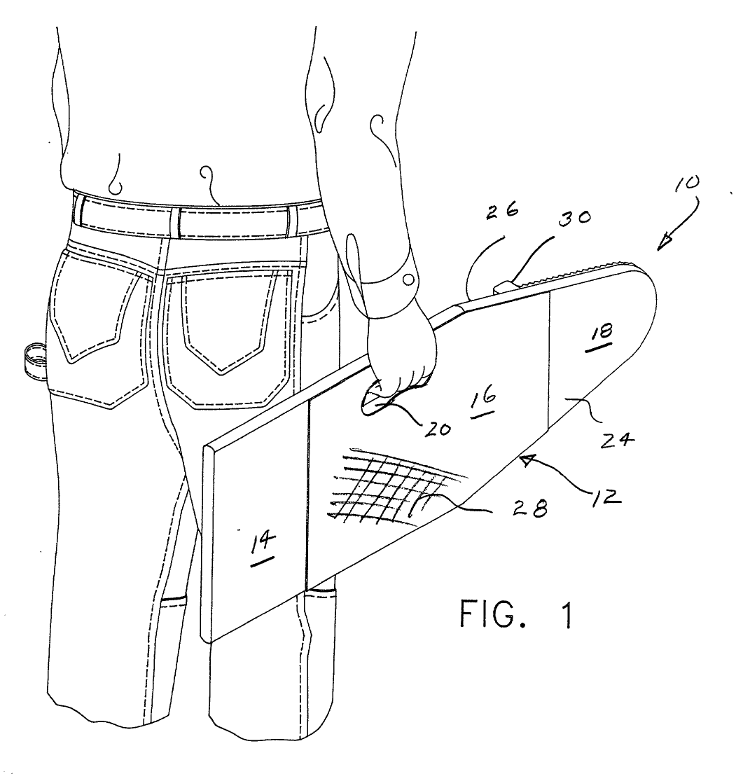

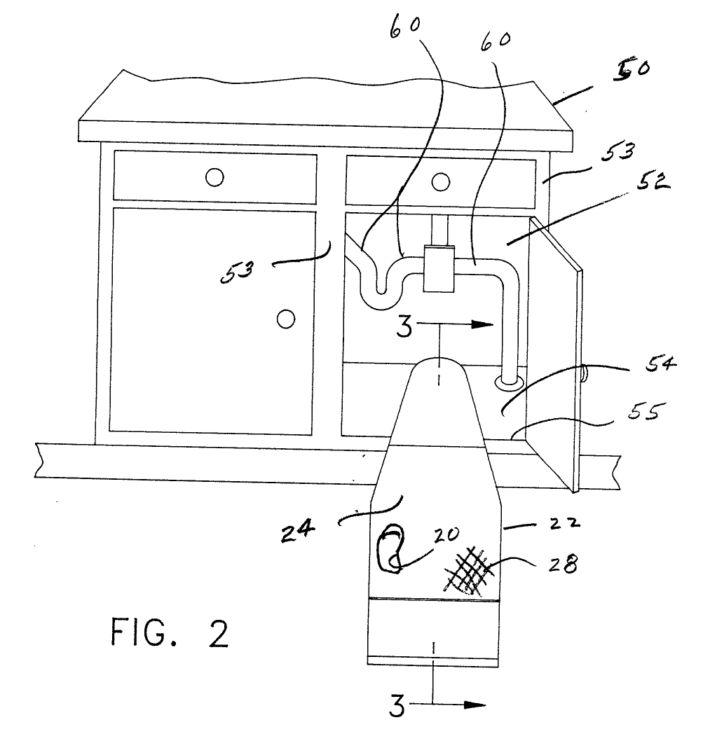

FIG. 1 shows the device 10 of the present invention being carried by a work person hereinafter for convenience referred to as a workman and illustrates a rough approximation as to the preferred size of the device in relationship to such workman. Normally the device 10 may be formed of any suitable material including wood, plastic or lightweight metal but and is preferably of the rather bullet-shaped appearance shown in the drawings, that is, having a body 12 including rear, central and forward portions 14, 16 and 18 respectively wherein the forward portion is of narrowed width proportion. Such forward portion 18 is bullet-shaped by the forward narrowing of the edges 22 which merge in a rounded nose 19 which shape better enables access to cabinets, etc. through narrower openings and its smooth shape prevents hang ups on cabinet vertical rails and the like. Particularly suitable dimensions for the device 10 would be of an overall length of 32 inches, a width of 12 inches at the central portion thereof and a thickness of approximately ½ inch. It should be pointed that such aforementioned dimensions are particularly suitable for wood but other dimensions may also be utilized especially when formed of other materials such as those suggested above. The central portion 16 is provided with an elongated opening or slot 20 proximal one of the opposed edges 22 thereof such that the device 10 may be easily carried by placing one's fingers through such opening 20 as depicted in FIG. 1. Such opening should also be preferably sized to accommodate gloved hands. The opening 20 preferably includes the upwardly curved configuration depicted for ease in grasping but may have alternate suitable shapes and is preferably positioned at the weight balance point of the device 10.

The body of the device includes an upper surface 24 which is of a generally flat or planar configuration and a lower opposed surface 26 similarly configured. Preferably a portion of the central portion of the upper surface 24 is provided with a layer or coating of a relatively high-frictional material such as an anti skid grit which may be either applied directly to the upper surface 24 or included by adhering an additional separate layer of frictional material to the upper surface thereof in any convenient fashion. Such frictional layer or surface 26 may additionally be provided by a coating or layer of an elastomeric material such as sheet rubber or the like—the intended overall purpose being that of providing a surface or layer 26 which when contacted by the workman's back while lying thereon in a supported prone position will enable the workman to manipulate the device 10 by shifting his position without slipping off the surface 24 of the device. The term “manipulate” is intended to include moving the device sideways, forwardly or rearwardly solely through the frictional force exerted to the upper surface of the device by the workman's back. In some cases as when the body 12 is formed from wood or some other inherently moderate or high frictional material, the use of a separate layer or coating 26 may be unnecessary. In addition, the non-skid or frictional surface could be alternatively achieved by placing commercially available non-skid strips on the surface 24 such as those available for use in shower stalls or on bathtub surfaces.

In addition, the body 12 is provided on its lower surface 26 with a major supporting stop 30 in the form of a downwardly extending bar terminating in a lower generally flat surface 32. The bar or stop 30 laterally extends across the lower surface 26 (at least a major portion thereof) such that there is adequate lateral extent when the device is placed on a supporting surface, that is, when the lower surface 32 is in contact with the supporting surface, it is unlikely the device will wobble when the workman laterally shifts his position or weight. Forwardly of the major stop 30 is a minor stop area 38 shown particularly in FIGS. 3 through 6 as taking the form of a separate elastomeric layer applied to a portion of the forward under surface 26 of the body 12. Such layer 40 may be attached as by gluing or the like to such surface and may include a series of ridges 42 extending laterally across the extent thereof and longitudinally separated from each other. Such layer 40 could take the general configuration of a shoe sole intended for adhesion or gripping to a supporting surface and may include a relatively smooth outer surface when the material forming such layer exhibits sufficient adhesion or gripping characteristics to assure a non-slip contact with the forward edge of the cabinet floor. This layer could be of an elastomeric material. In addition, the individual ridges 42 could be in some cases formed directly into the surface 26 of the forward end of the body 12, and it is unnecessary that the entire forward portion 18 be provided with such a surface. In addition, while elastomeric materials may provide the desired frictional contact between the cabinet and the device to assure positive longitudinal positioning therebetween, the mere presence of the longitudinally spaced ridges could achieve such result. The use of such surface is best shown in FIG. 3 of the drawings wherein the initial positioning of the device 10 is shown as applied to a cabinet 50 having an entrance 52 as defined by vertical rails 53 and a supporting shelf 54 which may or may not have an upwardly extending lip (not shown) at the entrance 52. The cabinet is depicted as housing drain lines 60 but obviously other common household fixtures including electrical boxes, sound system components and the like which might require repair are included.

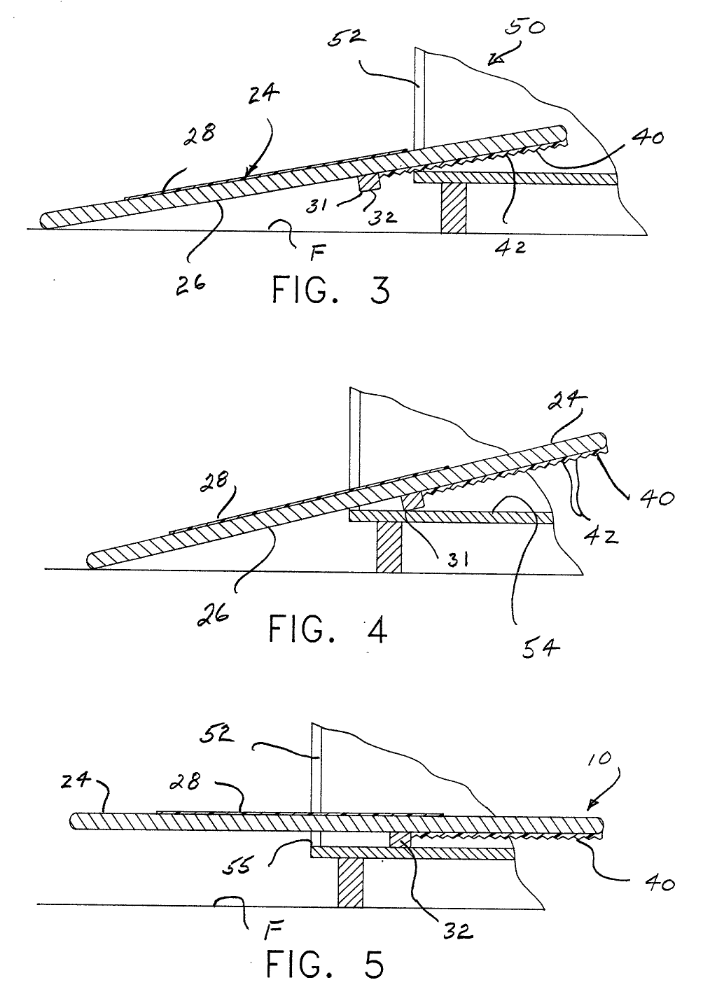

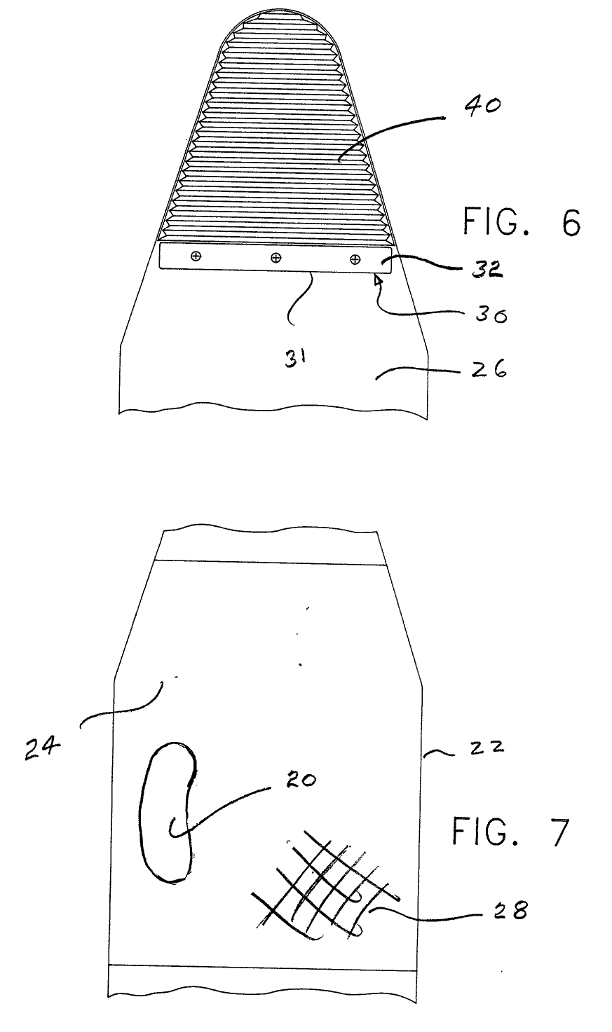

Operation of the device may include several steps or alternate manners of use including determining the plumbing problem by initial access to the cabinet. As shown in FIG. 3, the board is placed at an angular relationship so that its rear lower portion rests on the floor F and its forward lower surface particularly that portion thereof that is provided with the minor stop area or surface 38 contacting upper portions of the supporting floor 54 of the cabinet 50 especially the forward laterally extending edge 55 of the floor. In that position, the workman can lie in a position upon his back with his head partially supported by the upper surface of the forward portion 18 and feel comfortable that the device will not slide forwardly or rearwardly with respect to the cabinet because of the frictional contact with the minor stop area. Thereafter, once the problem is recognized, the device may be moved more inwardly into the cabinet 50 wherein the major stop 30 contacts the upper surface of the cabinet floor 54 and at that position the workman can either rest thereon as previously indicated, perform the work within the cabinet in either the slanted elevated position as shown in FIG. 4 or in a level position as shown in FIG. 5 by manipulating the supporting part of his weight from his legs or at the same time or in combination may move the device 10 inwardly and outwardly with respect to the cabinet 50 by moving his weight forwardly or rearwardly such that the contact of his back on the frictional surface 28 provided at the upper surface of the central portion 16 enabling such movement to be transmitted at least in part in a non-slip relationship with the support device. The above action enables the device to be moved in the intended manner solely by the workman's back contact with the device and thus enables him to keep both hands free for completing the plumbing task.

It should be noted that for safety and convenience to the worker in use and to also protect the floors and other surfaces contacted by the device, the body 12 is preferably provided with smooth round edge surfaces; and when the device is constructed of suitable wood material, such can be accomplished by routing all such edge surfaces. In addition, the somewhat textured rib surface shown as comprising the minor stop area 38 in the drawings could be more definitively defined as upstanding ribs which are longitudinally separated from each other so long as the overall intent of enabling the device 10 to be positioned in a generally angularly elevated position such as shown in FIG. 3 wherein the minor stop area contacts the forward section of the cabinet floor 54 with sufficient frictional force to prevent unintended longitudinal movement of the device with respect thereto. Whether such is accomplished by a high frictional textured surface or one having distinct ribs is not critical so long as the overall intended result is achieved. In addition, especially where only a portion of the forward portion under surface is provided with such minor stop area, it may be appropriate to recess that portion of the surface 24 intended to receive the minor support area 38 and then apply the layer of rubber or other material including such discreet ribs or textured surface in such recessed area. Furthermore, it should be pointed out that the major stop 30 can be formed of any suitable material; and in the case where the body 12 is formed of wood, such major stop 30 could be also be formed of wood and could be suitably fastened to the body by means of the screws shown in FIG. 6. In general,the operational manner of the device contemplates an initial placement of the body in the aforementioned first position manually by the workman after which he lays down on the upper surface of the body to determine the problem e.g. a leaking drain pipe and the necessary tools to repair the problem. Thereafter the worker manually places the body in the second position and resumes a lying attitude upon the upper surface from which position he can shift the body inwardly or outwardly with respect to the cabinet opening by fictional contact with his back thus leaving his hands free to effect the repairs. This back to upper body surface contact to move the device to a comfortable position and one from which the needed access to the cabinet is achieved is primarily during the second and third positions, it being noted that in thethird position the workmans lower legs may assume a right angle attitude with an otherwise parallel attitude of the workmans trunk. The device body sliding movement with respect to the cabinet floor is aided by the relatively low friction contact therewith by the rearward edge 31 of the major stop 30 during the second position and while the contact with the bottom flat surface of the major stop is more stable in the third position such still enables some sliding contact between the device and the cabinet floor.

While there is shown and described herein certain specific structure embodying this invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A support device adapted for a person to lie upon for working in the confined work area of a cabinet having a front opening and which work area includes a first general supporting floor and a second cabinet floor adjacent the first floor and generally parallel thereto and elevated therefrom and wherein the second cabinet floor includes a laterally extending forward edge, said support device comprising a broad generally flat body of overall elongated configuration and having central and rear portions and a narrowed dimensioned bullet-shaped forward portion, said body further having a first upper generally flat surface and an opposite generally flat second lower surface which lower surface includes a single narrow major supporting stop laterally extending across at least a major portion of said lower surface and downwardly extending therefrom, said major supporting stop in turn having a lower flat surface which is adapted to form a non-slip pivotal contact with either of the floors of the work area, a minor portion of said lower flat surface extending forwardly of said major stop, said major stop positioned proximal the forward portion of said body and adapted such that the person supported on the upper body surface with his or her head supported by the body forward portion can tilt the support device between alternate angular positions and a minor stop area provided on at least a major portion of said forward lower flat surface and which is adapted to non-slip frictionally contact the forward edge of the elevated second floor supporting surface of the work area, said support device adapted for a series of alternate positions with respect to the work area including a first position in which said rear portion of said body contacts the first floor and the lower flat surface of said forward portion of said body contacts the second floor so as to angularly position said support device a minor distance into the cabinet, a second position in which said rear portion of said body contacts the first floor and the lower surface of said major stop contacts the second floor so as to angularly position said support device a major distance into the cabinet and a third position in which said body is positioned parallel to the second floor and supported therefrom solely by contact therewith by the lower flat surface of said major stop.

2. The support device of claim 1 including a series of minor stops for functionally contacting a supporting surface of the work area.

3. The support device of claim 2, wherein said minor stops are defined by a layer of elastomeric material attached to said forward portion lower surface, said layer including a series of laterally downwardly extending ridges longitudinally separated from each other.

4. The support device of claim 1, including said upper surface having at least the central portion thereof provided with a high friction surface for contacting and holding the back of the person in contact therewith.

5. The support device of claim 4, wherein said high friction surface is formed by a layer of non-skid abrasive grit applied thereto.

6. The support device of claim 1 including an elongated slot extending through the central portion of the body proximal one side edge thereof for enabling hand carrying of the support device.

7. In combination, a worksite and a support device for accessing said worksite, said worksite including an open cabinet in which plumbing drain lines are housed and which includes a first general supporting floor and a cabinet second floor adjacent said first floor and generally parallel thereto and elevated therefrom, said second floor including a forward laterally extending edge, said floors defining first floor and second floor supporting surfaces, said supporting device comprising:
a broad generally flat body of overall elongated configuration and having forward, central and rear portions thereof, said body further having a first upper generally flat surface and an opposite generally flat second lower surface which lower surface includes a single narrow major supporting stop laterally extending across at least a major portion of said lower surface and downwardly extending therefrom, said major supporting stop in turn having a lower flat surface which is adapted to form a pivotal contact with either of the floors of such work area, a minor portion of said lower flat surface extending forwardly of said major stop, said major stop positioned proximal the forward portion of said body and adapted such that the person supported on the upper body surface with his or her head supported by the body forward portion can tilt the support device between alternate angular positions and a minor stop area provided on at least a major portion of said forward lower flat surface for non-slip frictionally contacting the forward edge of said elevated second floor supporting surface of the work area, said support device adapted for a series of alternate positions with respect to said worksite including a first position in which said rear portion of said body contacts said first floor and the lower flat surface of said forward portion of said body contacts said second floor so as to angularly position said support device a minor distance into said cabinet, a second position in which said rear portion of said body contacts said first floor and the lower surface of said major stop contacts said second floor so as to angularly position said support device a major distance into said cabinet and a third position in which said body is positioned parallel to said second floor and supported therefrom solely by contact therewith by the lower flat surface of said major stop.

8. The method of progressively manipulating a support device to enable a worker to access the interior of a cabinet through a forward cabinet opening wherein the cabinet further includes a bottom floor including a forward laterally extending edge and the support device includes a broad generally flat body of overall elongated configuration and having forward, central and rear portions thereof and wherein the body further has a first upper flat surface and an opposite flat second lower surface which lower surface includes a single narrow major supporting stop laterally extending there across and downwardly extending therefrom and wherein the major stop in turn includes a lower flat surface which is adapted to form a pivotal contact with either a general supporting floor on which the cabinet is supported or the cabinet bottom floor and wherein the second lower forward surface of the body includes a minor stop area for frictionally contacting the cabinet floor forward edge, comprising:
sequentially placing the body in a first position in which the rear portion of the body contacts the general supporting floor and the minor stop area contacts the cabinet floor forward edge thereby angularly positioning the forward portion of the support device a minor distance into the cabinet, thereafter placing the support device further into the cabinet to a second position in which the rear portion of the body contacts the general supporting floor and the lower surface of the major stop contacts the cabinet bottom floor and thereafter placing the support device in a third position in which the body is positioned parallel to the general supporting floor and is supported solely by contact with the cabinet bottom floor by the lower flat surface of the major stop.

9. The method of claim 8 wherein the progressive movements of the body with respect to the cabinet at least during the second and third positions are effected by the worker while laying on the first upper flat surface of the body.
